(19) United States
(12) Patent Application Publication
(10) Pub. No.: US 2024/0356187 A1
(43) Pub. Date: Oct. 24, 2024

(54) ELECTRICITY STORAGE DEVICE

(71) Applicant: Prime Planet Energy & Solutions, Inc., Tokyo (JP)

(72) Inventor: Tetsuya SAKAKIBARA, Nagoya-shi (JP)

(21) Appl. No.: 18/636,265

(22) Filed: Apr. 16, 2024

(30) Foreign Application Priority Data
Apr. 20, 2023 (JP) 2023-069148

(51) Int. Cl. H01M 50/60; H01M 50/627

(52) U.S. Cl. CPC H01M 50/668; H01M 50/627

(57) ABSTRACT

Provided is a technique for suppressing a splash of an electrolyte solution near a liquid injection hole in a case. An electricity storage device includes an electrode body, an insulating film, an electrolyte solution, and a case. The insulating film includes a first side surface opposed to a broad width surface of a body, is closed at a lower end closer to a bottom surface of the body, is opened at an upper end closer to a sealing plate, and further includes a notch at the upper end in the first side surface. In a cross-sectional view along a narrow width surface of the body, the notch is provided under an intersection of a straight line passing through center of the liquid injection hole and extending in a short side direction of the sealing plate and a straight line extending along the first side surface.

### CROSS REFERENCE OF RELATED APPLICATION

The present application claims the priority based on Japanese Patent Application No. 2023-069148 filed on Apr. 20, 2023, the entire contents of which are incorporated in the present specification by reference.

### BACKGROUND OF THE DISCLOSURE

### 1. Field

The present disclosure relates to an electricity storage device.

### 2. Background

Japanese Laid-open Patent Publication No. 2020-95836 discloses a battery including a rectangular battery case, an electrode body accommodated in the battery case, and an insulating film arranged between the battery case and the battery body. The battery case includes a body having an opening and a lid member that closes the opening. The body includes a bottom surface on an opposite side to the opening and a pair of long side surfaces each of which is continuous from the bottom surface and is erected therefrom. The insulating film has a shape of a single sheet and is arranged to extend at least along the electrode body, the bottom surface, and the pair of long side surfaces, and a pair of ends of the insulating film in a direction along a height from the bottom surface and the lid member are located closer to the lid member than the electrode body. In the insulating film, a cut is provided in a thickness direction of the insulating film at least in a portion of thereof that is located between a position corresponding to one end of the electrode body located closer to the lid member and a corresponding one of the pair of the ends of the insulating film and that is also in a width direction orthogonal to the height direction and along the long side surface. A portion from the cut to the pair of ends forms an inclined surface that is inclined toward the electrode body. In Japanese Laid-open Patent Publication No. 2020-95836, it is described that, in the battery having a configuration described above, a probability that a metal foreign matter is mixed into the electrode body is reduced.

A secondary battery disclosed in WO2018/131417 includes an electricity storage element formed of a portion obtained by disposing a mixture layer on a metal foil, an electrode body with a metal foil exposed portion, and a current collector connected to the metal foil exposed portion, a single insulating film that covers the electricity storage element, and a rectangular battery can that stores the electricity storage element and the insulating film and includes an opening, a bottom surface, and side surfaces. The insulating film is folded back at the bottom surface of the battery can to cover the electricity storage element, and includes a protrusion that protrudes from the electricity storage element to be opposed to a corresponding side surface of the battery can and in which portions of the insulating film overlap. A portion of the protrusion abuts on the side surface opposed to the protrusion in a direction in which the insulating film protrudes. A tip of the protrusion is arranged in a space between the electricity storage element and a corner portion of the rectangular battery can. In WO2018/131417, it is described that, in the secondary battery, by forming the insulating film between the mixture layer and a metal container into a uniform surface, damage, such as distortion or the like, on the mixture layer can be prevented, so that, with respect to external force, insulation between a wound group and the can can be enhanced.

A rectangular secondary battery disclosed in WO2016/088506 includes a flat electrode group obtained by winding positive and negative electrodes, a flat rectangular battery can that stores the electrode group, a battery lid that seals an opening of the battery can, and an insulating member fixed to the battery lid and stored in the battery can. The secondary battery includes a housing member having a smaller volume than that of the battery can and formed of a bag-like insulating sheet that is accommodated in the battery can and houses the electrode group with an electrolyte solution. The insulating member comes into close contact to the battery lid to seal a space between the insulating member and the battery lid and is joined at the opening of the housing member to seal the opening. In WO2016/088506, it is described that, with a configuration described above, an excess electrolyte solution that fills a space between the battery can and the housing member can be eliminated, so that the electrode group can be highly efficiently impregnated with the electrolyte solution in the housing member.

### SUMMARY

Incidentally, the inventor of the present application desires to suppress a splash of an electrolyte solution near a liquid injection hole in a case.

An electricity storage device disclosed herein includes an electrode body, a bag-like insulating film that covers the electrode body, an electrolyte solution, a case that houses the electrode body, the insulating film, and the electrolyte solution, an electrode terminal attached to the case, and a current collecting member connected to the electrode body and the electrode terminal inside the case. The case includes a body including a rectangular bottom surface, an opening opposed to the bottom surface, a pair of broad width surfaces each of which extends from a corresponding one of a pair of long sides of the bottom surface that are opposed to each other, and a pair of narrow width surfaces each of which extends from a corresponding one of a pair of short sides of the bottom surface that are opposed to each other, and a rectangular sealing plate that seals the opening. The sealing plate includes an attachment hole to which the electrode terminal is attached and a liquid injection hole through which the electrolyte solution is injected. The insulating film includes a first side surface opposed to a corresponding one of the broad width surfaces of the body. The insulating film is closed at a lower end that is closer to the bottom surface of the body and is opened at an upper end that is closer to the sealing plate. The insulating film has a notch in the upper end in the first side surface. In a cross-sectional view along the narrow width surface of the body, the notch is provided under an intersection of a straight line passing through center of the liquid injection hole and extending in a short side direction of the sealing plate and a straight line extending along the first side surface. According to a configuration described above, a splash of the electrolyte solution near the liquid injection hole can be suppressed in the case.

### BRIEF DESCRIPTION OF THE DRAWINGS

FIG. 1 is a cross-sectional view of an electricity storage device 1.

FIG. 2 is a cross-sectional view taken along line II-II of FIG. 1.

FIG. 3 is a cross-sectional view taken along line III-III of FIG. 1.

FIG. 4 is a schematic view of an electrode body 20.

FIG. 5 is a perspective view of an insulating film 70.

FIG. 6 is a cross-sectional view of the electricity storage device 1.

FIG. 7 is a front view of an insulating film 270.

FIG. 8 is a front view of an insulating film 370.

### DETAILED DESCRIPTION OF THE PREFERRED EMBODIMENTS

A preferred embodiment of a technology disclosed herein will be described below. The preferred embodiment described herein is not intended to be particularly limiting the technology disclosed herein. The technology disclosed herein is not limited to the preferred embodiment described herein, unless specifically stated otherwise. The accompanying drawings are schematic and do not necessarily reflect actual members or portions. Members/portions that have the same effect will be denoted by the same sign as appropriate and the overlapping description will be omitted as appropriate. Reference signs “R,” “L,” “U,” “D,” “F,” and “Rr” in the drawings respectively denote “right,” “left,” “up,” “down,” “front,” and “rear.” The notation “A to B” or the like that indicates a numerical range means “A or more and B or less” and also encompasses “more than A and less than B,” unless specifically stated otherwise.

As used in this specification, the term “electricity storage device” refers to devices in which charge carriers move between a pair of electrodes (a positive electrode and a negative electrode) via an electrolyte and thus a charging and discharging reaction occurs. Such electricity storage devices include secondary batteries, such as a lithium-ion secondary battery, a nickel hydrogen battery, a nickel cadmium battery, or the like and capacitors, such as a lithium-ion capacitor, an electric double-layered capacitor, or the like. A preferred embodiment in which, as an example of the electricity storage devices described above, a lithium-ion secondary battery is a target will be described below.

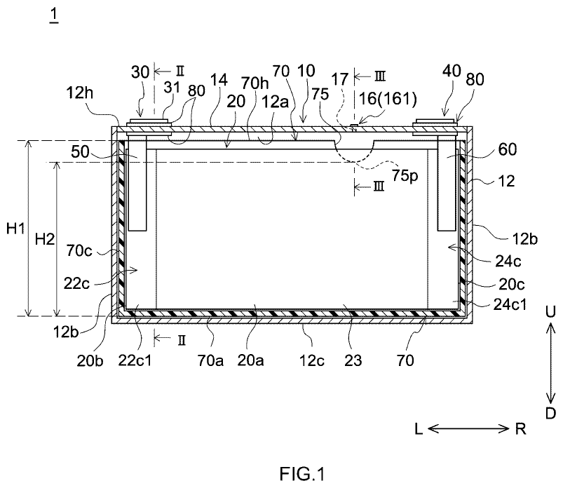

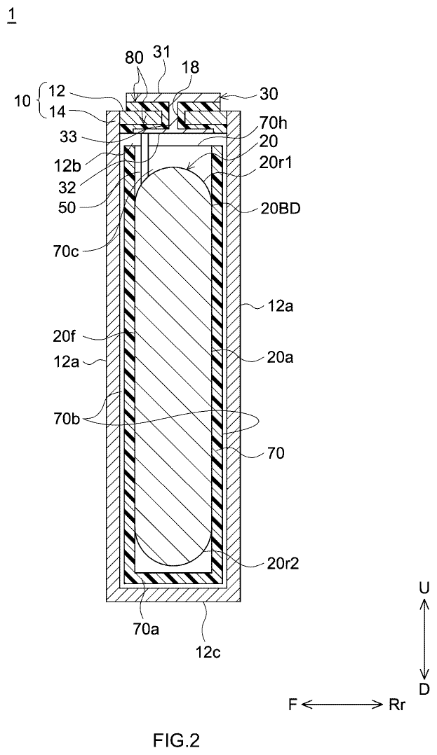

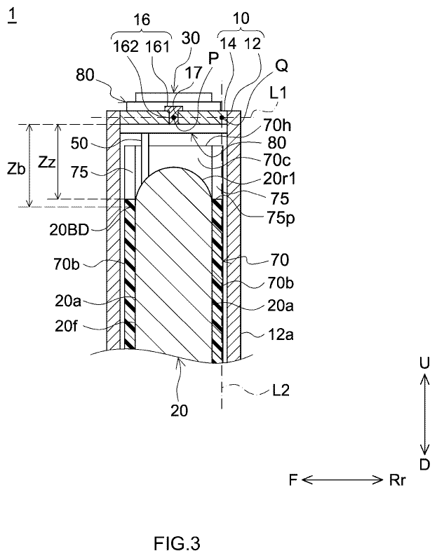

FIG. 1 is a cross-sectional view of an electricity storage device 1. In FIG. 1, a cross-sectional structure of the electricity storage device 1 along a broad width surface 12a is illustrated. FIG. 2 is a cross-sectional view taken along line II-II of FIG. 1. In FIG. 2, a cross-sectional structure near a terminal connection portion at a positive electrode side along a narrow width surface 12b is illustrated. FIG. 3 is a cross-sectional view taken along line III-III of FIG. 1. In FIG. 3, a cross-sectional structure near a liquid injection hole 17 along the narrow width surface 12b is illustrated. As illustrated in FIG. 1 to FIG. 3, the electricity storage device 1 includes a case 10, an electrode body 20, a positive electrode terminal 30, a negative electrode terminal 40, a current collecting member 50 at the positive electrode side, a current collecting member 60 at a negative electrode side, an insulating film 70, an insulating member 80, and an unillustrated electrolyte solution.

The case 10 is, for example, a member that houses the electrode body 20, the insulating film 70, and the electrolyte solution. In terms of reducing a weight and ensuring desired stiffness, for example, the case 10 may be formed of aluminum or an aluminum alloy, but not limited to.

As illustrated in FIG. 1 to FIG. 3, the case 10 includes a body 12 and a sealing plate 14. The body 12 is a body of the case 10 that houses, for example, the electrode body 20 therein. In this preferred embodiment, the body 12 includes an opening 12h, a pair of broad width surfaces 12a opposed to each other, a pair of narrow width surfaces 12b opposed to each other, and a bottom surface 12c. The bottom surface 12c is opposed to the opening 12h herein. The bottom surface 12c has a rectangular shape herein and has a pair of long sides opposed to each other and a pair of short sides opposed to each other. The pair of broad width surfaces 12a opposed to each other are surfaces each of which extends from a corresponding one of the pair of long sides of the bottom surface 12c opposed to each other. The pair of narrow width surfaces 12b opposed to each other are surfaces each of which extends from a corresponding one of the pair of short sides of the bottom surface 12c opposed to each other. Note that, in this specification, the description of “rectangular” or “rectangle” encompasses a shape in which a linear long side and a linear short side are joined to each other via a curved line, a shape in which at least one of the long side and the short side is not linear but is curved, uneven, bent and formed of multiple straight or curved lines, or the like.

The opening 12h is, for example, a member to which the sealing plate 14 is mounted. Herein, the opening 12h is formed by upper ends of the pair of broad width surfaces 12a and upper ends of the pair of narrow width surfaces 12b surrounding the opening 12h, and has a rectangular shape. The sealing plate 14 is fitted in the opening 12h and is joined (for example, welded) thereto, so that the body 12 and the sealing plate 14 are integrated and the case 10 is air-tightly sealed.

The sealing plate 14 is, for example, a flat plate-like member that seals the opening 12h. Therefore, the sealing plate 14 may have a corresponding shape to a shape of the opening 12h. In this preferred embodiment, the sealing plate 14 has a rectangular shape. Herein, when the sealing plate 14 is attached to the opening 12h, the sealing plate 14 is, for example, opposed to the bottom surface 12c. The sealing plate 14 includes a discharge valve (not illustrated) and the liquid injection hole 17. The discharge valve is, for example, a thin portion. Herein, the discharge valve is configured to break and discharge gas out of the case 10 when a pressure in the case 10 becomes equal to or more than a predetermined value.

The liquid injection hole 17 is a member through which an electrolyte solution is injected. As illustrated in FIG. 3, a sealing member 16 is attached to the liquid injection hole 17. The sealing member 16 may be, for example, formed of metal. In a configuration illustrated in FIG. 3, the sealing member 16 includes a flange portion 161 and an insertion portion 162. The flange portion 161 is a plate-like member herein, and is arranged on the sealing plate 14, and is joined (for example, welded) to the sealing plate 14. The insertion portion 162 is a member that has a shaft-like shape or a protruding shape and is inserted in the liquid injection hole 17. Note that a shape of the sealing member 16 is not limited thereto. In another preferred embodiment, the sealing member 16 may be formed of the flange portion 161.

In this preferred embodiment, the sealing plate 14 includes an attachment hole to which an electrode terminal is attached. In a configuration illustrated in FIG. 2, an attachment hole 18 at the positive electrode side is provided in the sealing plate 14. The attachment hole 18 is herein a through hole. The attachment hole 18 is, for example, a member to which the positive electrode terminal 30 is attached. Although not illustrated, an attachment hole at a negative electrode side is provided in the sealing plate 14. Similar to the attachment hole 18, the attachment hole at the negative electrode side is a through hole. The attachment hole at the negative electrode side is a member to which the negative electrode terminal 40 is attached.

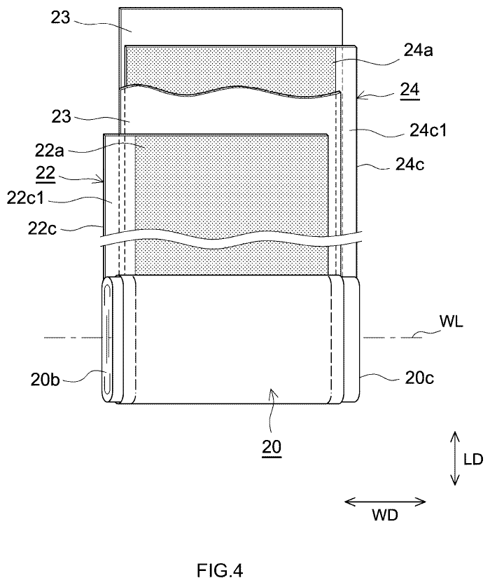

FIG. 4 is a schematic view of the electrode body 20. The electrode body 20 is, for example, an electricity generation element of the electricity storage device 1 that includes a positive electrode and a negative electrode. The electrode body 20 has, for example, a stacked structure in which a sheet-like positive electrode 22 and a sheet-like negative electrode 24 are stacked with a separator 23 interposed therebetween. The electrode body 20 is housed in the case 10 with the sheet-like positive electrode 22 and the sheet-like negative electrode 24 stacked such that a stacking direction of the positive electrode 22 and the negative electrode 24 is a direction toward the pair of broad width surfaces 12a.

As illustrated in FIG. 4, the electrode body 20 is, for example, a wound electrode body formed by stacking the sheet-like positive electrode 22 and the sheet-like negative electrode 24 with the separator 23 interposed therebetween and winding a stacked body in a sheet longitudinal direction LD. The electrode body 20 can be formed, for example, by winding the positive electrode 22, the negative electrode 24, and the separator 23 into a cylindrical body and pressing the cylindrical body. Therefore, the electrode body 20 has a flat shape.

As illustrated in FIG. 2 and FIG. 3, the electrode body 20 includes a first curved portion 20r1, a second curved portion 20r2, and a flat portion 20f. The first curved portion 20r1 is a member that is arranged closer to the sealing plate 14 and is curved toward an inner surface of the sealing plate 14. The second curved portion 20r2 is a member that is arranged closer to the bottom surface 12c of the case 10 and is curved toward the bottom surface 12c. The flat portion 20f is a member between the first curved portion 20r1 and the second curved portion 20r2. In this preferred embodiment, the electrode body 20 includes a pair of flat surfaces 20a. The flat surfaces 20a are at both ends in the stacking direction of the positive electrode 22 and the negative electrode 24. Herein, the flat surfaces 20a are at both ends of the flat portion 20f. Each of the flat surfaces 20a of the electrode body 20 is opposed to a corresponding one of the broad width surfaces 12a.

One end surface 20b of the electrode body 20 is opposed to one of the narrow width surfaces 12b (the narrow width surface 12b at left in FIG. 1) and the other end surface 20c is opposed to the other one of the narrow width surfaces 12b (the narrow width surface 12b at right in FIG. 1). The end surface 20b is herein a stacked surface of a non-coated portion 22c1 of a positive electrode current collecting foil 22c, and is an open surface. The end surface 20c is herein a stacked surface of a non-coated portion 24c1 of a negative electrode current collecting foil 24c, and is an open surface. As illustrated in FIG. 1 and FIG. 4, the electrode body 20 is housed in the body 12 such that a winding axis direction WD and a left-right direction of the electricity storage device 1 are substantially in parallel to each other. A winding axis WL of the electrode body 20 is substantially perpendicular to the broad width surfaces 12a and the narrow width surfaces 12b and is substantially in parallel to the sealing plate 14.

As illustrated in FIG. 4, the positive electrode 22 includes a long band-like positive electrode current collecting foil 22c (for example, aluminum foil) and a positive electrode active material layer 22a fixed on at least one surface of the positive electrode current collecting foil 22c. A protective layer (not illustrated) may be provided in one side edge portion of the positive electrode 22 in the winding axis direction WD as necessary, but not particularly limited to. Note that, as a constituent material of the positive electrode active material layer 22a and a constituent material of the protective layer, materials used for electricity storage devices of this type (in this preferred embodiment, a lithium-ion secondary battery) may be used without limitation.

The band-like non-coated portion 22c1 is provided to extend in the longitudinal direction LD in one end (a left end in FIG. 4) of the positive electrode current collecting foil 22c in the winding axis direction WD. The non-coated portion 22c1 is a portion of the positive electrode current collecting foil 22c. The non-coated portion 22c1 is a member to which the positive electrode active material layer 22a is not applied in the positive electrode current collecting foil 22c. In this preferred embodiment, the non-coated portion 22c1 protrudes from the separator 23 in the winding axis direction WD. The non-coated portion 22c1 is stacked at one end (the left end in FIG. 4) in the winding axis direction WD. As illustrated in FIG. 1, the current collecting member 50 is joined to the non-coated portion 22c1.

As illustrated in FIG. 4, the negative electrode 24 includes the long band-like negative electrode current collecting foil 24c (for example, copper foil) and a negative electrode active material layer 24a fixed on at least one surface of the negative electrode current collecting foil 24c. Note that, as a constituent material of the negative electrode active material layer 24a, materials used for electricity storage devices of this type (in this preferred embodiment, a lithium-ion secondary battery) may be used without limitation.

The band-like non-coated portion 24c1 is provided to extend in the longitudinal direction LD in one end (a right end in FIG. 4) of the negative electrode current collecting foil 24c in the winding axis direction WD. The non-coated portion 24c1 is a portion of the negative electrode current collecting foil 24c. The non-coated portion 24c1 is a member in which the negative electrode active material layer 24a is not formed in the negative electrode current collecting foil 24c. In this preferred embodiment, the non-coated portion 24c1 protrudes from the separator 23 in the winding axis direction WD. For example, the non-coated portion 24c1 is stacked at one end (the right end in FIG. 4) in the winding axis direction WD. As illustrated in FIG. 1, the current collecting member 60 is joined to the non-coated portion 24c1.

The separator 23 is a member that insulates between the positive electrode active material layer 22a of the positive electrode 22 and the negative electrode active material layer 24a of the negative electrode 24. The separator 23 forms an outer surface of the electrode body 20 in this preferred embodiment. As the separator 23, for example, a resin porous sheet made of polyolefin resin such as polyethylene (PE), polypropylene (PP), or the like is used.

The positive electrode terminal 30 is, for example, a member that is electrically connected to the positive electrode 22 of the electrode body 20. As illustrated in FIG. 2, the positive electrode terminal 30 is inserted through the attachment hole 18 and is arranged outside and inside the body 12. The positive electrode terminal 30 herein includes a first conductive portion 31, a second conductive portion 32, and a shaft portion 33. The first conductive portion 31 is, for example, a member arranged outside the case 10. In the configuration illustrated in FIG. 1 and FIG. 2, the first conductive portion 31 has a flat shape and is arranged along an outer surface of the sealing plate 14. The second conductive portion 32 is, for example, a member arranged inside the case 10. In the configuration illustrated in FIG. 2, the second conductive portion 32 has a flat shape and is arranged along an inner surface of the sealing plate 14. The shaft portion 33 is, for example, a member that has a cylindrical shape, is inserted through the attachment hole 18, and connects the first conductive portion 31 and the second conductive portion 32. In the configuration illustrated in FIG. 2, the shaft portion 33 extends from the first conductive portion 31 and is connected to the second conductive portion 32. For example, a through hole may be provided in the second conductive portion 32. In this case, a tip of the shaft portion 33 may be inserted in the through hole and caulked. Thus, connection of the first conductive portion 31 and the second conductive portion 32 by the shaft portion 33 can be achieved. Alternatively, the first conductive portion 31, the second conductive portion 32, and the shaft portion 33 may be integrally molded. The positive electrode terminal 30 is formed of, for example, aluminum or an aluminum alloy.

The current collecting member 50 at the positive electrode side is, for example, a member that electrically connects the positive electrode 22 and the positive electrode terminal 30 inside the case 10. In the configuration illustrated in FIG. 1, the current collecting member 50 has a plate-like shape and extends from the sealing plate 14 toward the electrode body 20. The current collecting member 50 herein is connected to the second conductive portion 32 at one end (an upper end in FIG. 1) and is connected to the electrode body 20 at the other end (a lower end in FIG. 1). Therefore, as illustrated in FIG. 2, between an upper end of the electrode body 20 and the sealing plate 14, the current collecting member 50 is sandwiched between the insulating film 70 and the insulating film 70. In this preferred embodiment, connection of the current collecting member 50 and the second conductive portion 32 is achieved by joining (for example, welding) one end of the current collecting member 50 and the second conductive portion. In this preferred embodiment, connection of the current collecting member 50 and the electrode body 20 is achieved by joining (for example, welding) the other end of the current collecting member 50 and the non-coated portion 22c1. The current collecting member 50 is formed of, for example, aluminum and an aluminum alloy.

The negative electrode terminal 40 is, for example, a member that is electrically connected to the negative electrode 24 of the electrode body 20. The negative electrode terminal 40 is formed of, for example, copper or a copper alloy. The negative electrode terminal 40 may have, for example, a similar configuration to that of the positive electrode terminal 30. Therefore, description of the configuration of the negative electrode terminal 40 is omitted herein. The current collecting member 60 at the negative electrode side is, for example, a member that electrically connects the negative electrode 24 and the negative electrode terminal 40 inside the case 10. The current collecting member 60 is formed of, for example, copper or a copper alloy. The current collecting member 60 at the negative electrode side may have, for example, a similar configuration to that of the current collecting member 50 at the positive electrode side. Therefore, description of the configuration of the current collecting member 60 is omitted herein.

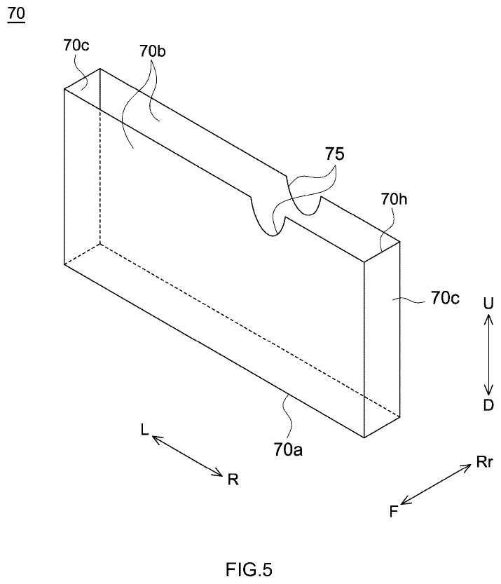

The insulating film 70 is, for example, a member that covers the electrode body 20. FIG. 5 is a perspective view of the insulating film 70. As illustrated in FIG. 5, the insulating film 70 has a bag-like shape and a portion thereof is opened. As illustrated in FIG. 1 to FIG. 3 and FIG. 5, the insulating film 70 is closed at a lower end and is opened at an upper end. Note that, in this specification, for the insulating film 70, an end thereof at a side closer to the bottom surface 12c of the body 12 is the “lower end” and an end thereof at a side closer to the sealing plate 14 is the “upper end.”

The insulating film 70 illustrated in FIG. 5 has a substantially hexahedral shape one surface of which is opened. In this preferred embodiment, the insulating film 70 includes a bottom surface 70a, a pair of first side surfaces 70b opposed to each other, and a pair of second side surfaces 70c opposed to each other. The insulating film 70 includes an opening 70h opposed to the bottom surface 70a. The bottom surface 70a has a rectangular shape herein. As illustrated in FIG. 5, each of the pair of first side surfaces 70b extends from a corresponding one of a pair of long sides of the bottom surface 70a opposed to each other and is a broadest surface in the insulating film 70. Each of the pair of second side surfaces 70c extends from a corresponding one of a pair of short sides of the bottom surface 70a opposed to each other. In the configuration illustrated in FIG. 2, in the case 10, the bottom surface 70a is opposed to the bottom surface 12c of the body 12. Herein, the bottom surface 70a forms a lower end of the insulating film 70. Each of the pair of first side surfaces 70b is opposed to a corresponding one of the pair of broad width surfaces 12a of the body 12. Furthermore, the opening 70h is arranged closer to the opening 12h of the body 12. Herein, the opening 70h forms an upper end of the insulating film 70.

As illustrated in FIG. 1, FIG. 3 and FIG. 5, the insulating film 70 includes a notch 75 in the upper end in each of the first side surfaces 70b. In a cross section illustrated in FIG. 3, the notch 75 is provided under an intersection Q of a straight line L1 and a straight line L2. Herein, the “cross section illustrated in FIG. 3” is a cross section passing through center P of the liquid injection hole 17 and extending along the narrow width surface 12b of the body 12. The straight line L1 is a straight line passing through the center P of the liquid injection hole 17 and extending in a short side direction of the rectangular sealing plate 14 in the cross section illustrated in FIG. 3. The straight line L2 is a straight line extending along the first side surfaces 70b of the insulating film 70 in the cross section illustrated in FIG. 3. In the configuration illustrated in FIG. 1, FIG. 3, and FIG. 5, the notch 75 is provided in each of the first side surfaces 70b. However, the notch 75 is not limited thereto. In another embodiment, the notch 75 may be provided in only one of the pair of first side surfaces 70b.

As illustrated in FIG. 2, each of the first side surfaces 70b is opposed to the current collecting member 50. As illustrated in FIG. 1, when the lower end of the insulating film 70 serves as a reference, a height H1 of the upper end of each of the first side surfaces 70b in a portion opposed to the current collecting member 50 may be larger than a height H2 of a deepest portion 75p of the notch 75. The “deepest portion 75p of the notch 75” is a portion having a smallest height in the notch 75 when the lower end of the insulating film 70 serves as a reference.

In the configuration illustrated in FIG. 3, the deepest portion 75p of the notch 75 is provided between a boundary 20BD of the first curved portion 20r1 and the flat portion 20f and the sealing plate 14. A depth Zb from the inner surface of the sealing plate 14 to the boundary 20BD and a depth Zz from the inner surface of the sealing plate 14 to the deepest portion 75p may be set to satisfy Zz≤Zb. From a viewpoint of enhancing an effect of the technology disclosed herein, the deepest portion 75p of the notch 75 is preferably provided in a position closer to the sealing plate 14 than the boundary 20BD of the first curved portion 20r1 and the flat portion 20f. In this case, the depth Zb and the depth Zz can satisfy Zz<Zb.

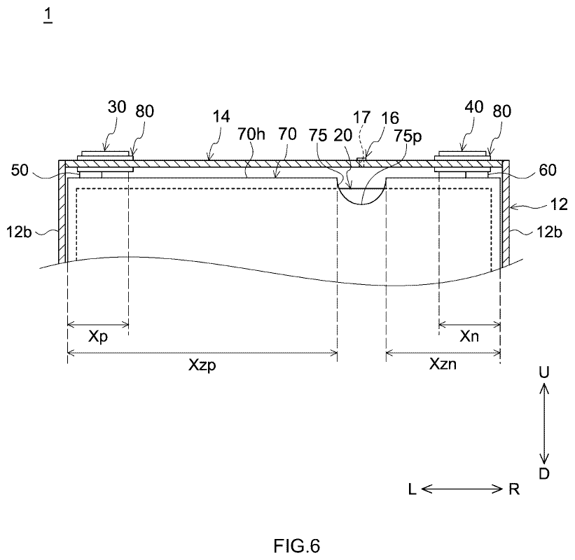

FIG. 6 is a cross-sectional view of the electricity storage device 1. In FIG. 6, a portion of the cross-sectional structure of the electricity storage device 1 along the broad width surface 12a located near the sealing plate 14 is enlarged and illustrated. In FIG. 6, for an arrangement relation between the positive electrode terminal 30, the negative electrode terminal 40, the liquid injection hole 17, and the notch 75, an example that is preferable for achieving the effect of the technology disclosed herein is illustrated. As illustrated in FIG. 6, in the case 10, a distance Xp from the narrow width surface 12b to the positive electrode terminal 30 and a distance Xzp from the narrow width surface 12b to an end of the notch 75 closer to the positive electrode terminal 30 preferably satisfies Xp≤Xzp, and more preferably satisfies Xp<Xzp. Herein, the distance Xp is a shortest distance from the narrow width surface 12b to an end of the second conductive portion 32 closer to the liquid injection hole 17. In the case 10, a distance Xn from the narrow width surface 12b to the negative electrode terminal 40 and a distance Xzn from the narrow width surface 12b to an end of the notch 75 closer to the negative electrode terminal 40 preferably satisfies Xn≤Xzn, and more preferably satisfies Xn<Xzn. Herein, the distance Xzn is a shortest distance from the narrow width surface 12b to an end of the second conductive portion of the negative electrode terminal 40 closer to the liquid injection hole 17.

As illustrated in FIG. 1 to FIG. 3, the insulating members 80 are provided between the positive electrode terminal 30 and the sealing plate 14 and between the negative electrode terminal 40 and the sealing plate 14. For example, the insulating member 80 is arranged to extend between the first conductive portion 31 and the outer surface of the sealing plate 14, between the second conductive portion 32 and the inner surface of the sealing plate 14, and between the shaft portion 33 and the attachment hole 18. Similarly, at the negative electrode side, for example, the insulating member 80 is arranged to extend between the negative electrode terminal 40 and each of the outer surface of the sealing plate 14, the inner surface of the sealing plate 14, and the attachment hole. The insulating member 80 may be an integrally molded member, and may be a combination of members each of which is separately molded.

The electrolyte solution contains, for example, an electrolyte salt and a nonaqueous solvent. Examples of the electrolyte salt include, for example, LiPF₆ or the like. A concentration of the electrolyte salt in the electrolyte solution is, for example, 0.7 mol/L to 1.3 mol/L. The nonaqueous solvent may be, for example, carbonates. Examples of carbonates include, for example, ethylene carbonate (EC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), trifluorodimethyl carbonate (TFDMC), or the like. One of the carbonates described above can be individually used or two or more thereof can be combined and used.

The electricity storage device 1 is used for various applications. In particular, the electricity storage device 1 can be preferably used as a power source (a drive power source) for a motor mounted on a vehicle, such as a passenger vehicle, a truck, or the like. There is no particular limitation on a vehicle type. Preferable examples of the vehicle type include, for example, a plug-in hybrid electric vehicle (PHEV), a hybrid electric vehicle (HEV), a battery electric vehicle (BEV), or the like.

As described above, the electricity storage device 1 includes the electrode body 20, the bag-like insulating film 70 that covers the electrode body 20, the electrolyte solution, the case 10 that houses the electrode body 20, the insulating film 70, and the electrolyte solution, the electrode terminals (the positive electrode terminal 30 and the negative electrode terminal 40) attached to the case 10, and the current collecting members 50 and 60 each of which is connected to the electrode body 20 and a corresponding one of the electrode terminals (the positive electrode terminal 30 and the negative electrode terminal 40) inside the case 10. The case 10 includes the body 12 that includes the rectangular bottom surface 12c, the opening 12h opposed to the bottom surface 12c, the pair of broad width surfaces 12a each of which extends from a corresponding one of the pair of long sides of the bottom surface 12c that are opposed to each other, and the pair of narrow width surfaces 12b each of which extends from a corresponding one of the pair of short sides of the bottom surface 12c that are opposed to each other, and the rectangular sealing plate 14 that seals the opening 12h. The sealing plate 14 includes an attachment hole (for example, the attachment hole 18 at the positive electrode side) to which a corresponding one of the electrode terminals (the positive electrode terminal 30 and the negative electrode terminal 40) is attached, and the liquid injection hole 17 through which the electrolyte liquid is injected.

Herein, the insulating film 70 includes the first side surfaces 70b each of which is opposed to a corresponding one of the broad width surfaces 12a of the body 12. The insulating film 70 is closed at a lower end closer to the bottom surface 12c of the body 12 and is opened at an upper end closer to the sealing plate 14. The insulating film 70 includes the notch 75 in the upper end in each of the first side surfaces 70b. In a cross section along the narrow width surface 12b of the body 12, the notch 75 is provided under the intersection Q of the straight line L1 passing through the center P of the liquid injection hole 17 and extending in the short side direction of the sealing plate 14 and the straight line L2 extending along the first side surface 70b.

In the electricity storage device 1, in a cross section along the narrow width surface 12b of the body 12, the notch 75 is provided under the intersection Q of the straight line L1 passing through the center P of the liquid injection hole 17 and extending in the short side direction of the rectangular sealing plate 14 and the straight line L2 extending along the first side surface 70b of the insulating film 70. Thus, in the notch 75, the upper end of the insulating film 70 can be arranged away from liquid injection hole 17. Therefore, the upper end of the insulating film 70 on which the electrolyte solution creeped up, for example, due to a capillary phenomenon can be kept away from the liquid injection hole 17. Thus, in the case 10, a splash of the electrolyte solution near the liquid injection hole 17 can be suppressed. Accordingly, for example, a joining failure of the sealing member 16 to the liquid injection hole 17 can be suppressed.

In the electricity storage device 1, the notch 75 may be provided closer to center of the long side of the sealing plate 14 than a connection portion (for example, a joining portion) of the positive electrode terminal 30 and the current collecting member 50 and a connection portion (for example, a joining portion) of the negative electrode terminal 40 and the current collecting member 60. Thus, a contact suppression effect between each of the positive electrode terminal 30 and the negative electrode terminal 40 and a corresponding one of the current collecting member 50 and the current collecting member 60 and the inner surface of the case 10 in vicinity of the attachment hole (for example, the attachment hole 18) by the insulating film 70 can be properly maintained.

The electrode body 20 may be a wound electrode body formed by winding the long sheet-like positive electrode 22 and the long sheet-like negative electrode 24 with the long sheet-like separator 23 interposed therebetween in the longitudinal direction. The electrode body 20 may include the first curved portion 20r1, the second curved portion 20r2, and the flat portion 20f provided between the first curved portion 20r1 and the second curved portion 20r2. The electrode body 20 may be housed in the case 10 such that the first curved portion 20r1 is arranged closer to the sealing plate 14 and the second curved portion 20r2 is arranged closer to the bottom surface 12c. The deepest portion 75p of the notch 75 may be provided closer to the sealing plate 14 than the boundary 20BD of the first curved portion 20r1 and the boundary 20BD. The boundary 20BD can be considered as a closest portion to the sealing plate 14 among portions that can contact the case 10 in the electrode body 20. Therefore, by arranging the deepest portion 75p of the notch 75 closer to the sealing plate 14 than the boundary 20BD, a contact suppression effect between the electrode body 20 and the case 10 can be properly maintained.

In the electricity storage device 1, the positive electrode terminal 30 may include the first conductive portion 31 arranged outside the case 10, the second conductive portion 32 arranged inside the case 10, and the shaft portion 33 inserted through the attachment hole 18 and connecting the first conductive portion 31 and the second conductive portion 32. The current collecting member 50 may be configured to extend from the sealing plate 14 toward the electrode body 20, be connected to the second conductive portion 32 at one end, and be connected to the electrode body 20 at the other end. Between the boundary 20BD of the first curved portion 20r1 and the flat portion 20f and the sealing plate 14, the current collecting member 50 may be sandwiched between the insulating film 70 and the insulating film 70. Thus, a risk of contact of the current collecting member 50 and the case 10 can be reduced by the insulating film 70. As for the negative electrode terminal 40, since the negative electrode terminal 40 is similar to the positive electrode terminal 30, description thereof is omitted herein.

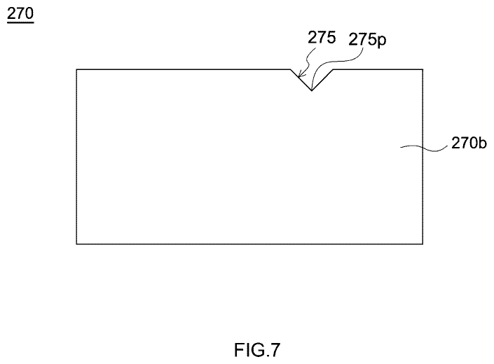

There is no particular limitation on a shape of the notch 75 but, as illustrated in FIG. 1, FIG. 5, and FIG. 6, the notch 75 may have a semicircular shape. In this case, center of a half circle is directly under the intersection Q (see FIG. 3) of the straight line L1 and the straight line L2. Alternatively, the notch 75 may be a notch having a different shape from a semicircular shape as long as the effect of the technology disclosed herein can be achieved. FIG. 7 is a front view of an insulating film 270. In FIG. 7, a view of the insulating film 270 when viewed from a first side surface 270b side is illustrated. As illustrated in FIG. 7, a notch 275 may have a triangular shape. In this case, the notch 275 may have an isosceles triangular shape having a deepest portion 275p as a vertex. The deepest portion 275p is preferably directly under the intersection Q (see FIG. 3) of the straight line L1 and the straight line L2. By the shape of the notch 75 or the shape of the notch 275 described above, and also by the insulating film 70 or the insulating film 270, the effect of the technology disclosed herein can be achieved, and an effect of reducing the risk of contact of the current collecting member 50 and the current collecting member 60 with the case 10 can be enhanced.

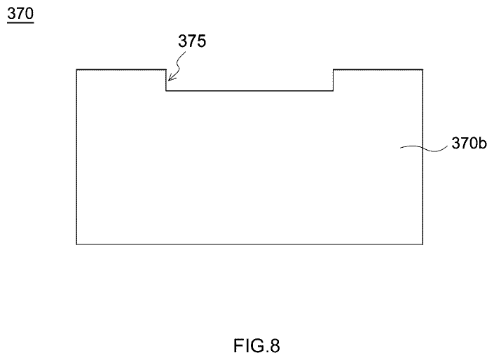

FIG. 8 is a front view of an insulating film 370. In FIG. 8, a view of the insulating film 370 when viewed from a first side surface 370b side is illustrated. As illustrated in FIG. 8, a notch 375 may have a rectangular shape. By forming the notch 375 into a shape described above, an upper end of the insulating film 370 can be arranged away from the liquid injection hole 17 in a wider range. Thus, an effect of suppressing a splash of the electrolyte solution to a portion near the liquid injection hole 17 in the case 10 can be further enhanced.

As described above, the following items are given as specific aspects of the technology disclosed herein.

### Item 1:

An electricity storage device comprising:
an electrode body;
a bag-like insulating film that covers the electrode body;
an electrolyte solution;
a case that houses the electrode body, the insulating film, and the electrolyte solution and includes
   a body including a rectangular bottom surface, an opening opposed to the bottom surface, a pair of broad width surfaces each of which extends from a corresponding one of a pair of long sides of the bottom surface that are opposed to each other, and a pair of narrow width surfaces each of which extends from a corresponding one of a pair of short sides of the bottom surface that are opposed to each other, and
   a rectangular sealing plate that seals the opening;
an electrode terminal attached to the case; and
a current collecting member connected to the electrode body and the electrode terminal inside the case,
wherein
the sealing plate includes an attachment hole to which the electrode terminal is attached and a liquid injection hole through which the electrolyte solution is injected, and
the insulating film
   includes a first side surface opposed to a corresponding one of the broad width surfaces of the body,
   is closed at a lower end that is closer to the bottom surface of the body and is opened at an upper end that is closer to the sealing plate, and
   has a notch in the upper end in the first side surface, and
in a cross-sectional view along the narrow width surface of the body, the notch is provided under an intersection of a straight line passing through center of the liquid injection hole and extending in a short side direction of the sealing plate and a straight line extending along the first side surface.

### Item 2:

The electricity storage device according to item 1, wherein
the notch is provided closer to center of a long side of the sealing plate than a connection portion of the electrode terminal and the current collecting member.

### Item 3:

The electricity storage device according to item 1 or 2, wherein
the electrode body
   is a wound electrode body formed by winding a long sheet-like positive electrode and a long sheet-like negative electrode with a long sheet-like separator interposed therebetween in a longitudinal direction,
   includes a first curved portion, a second curved portion, and a flat portion provided between the first curved portion and the second curved portion, and
   is housed in the case such that the first curved portion is arranged closer to the sealing plate and the second curved portion is arranged closer to the bottom surface, and
a deepest portion of the notch is provided closer to the sealing plate than a boundary of the first curved portion and the flat portion.

### Item 4:

The electricity storage device according to item 3, wherein
the electrode terminal includes
   a first conductive portion arranged outside the case,
   a second conductive portion arranged inside the case, and
   a shaft portion inserted through the attachment hole and connecting the first conductive portion and the second conductive portion,
the current collecting member
   extends from the sealing plate toward the electrode body, is connected to the second conducive portion at one end, and is connected to the electrode body at the other end, and
   between the boundary in the electrode body and the sealing plate, is sandwiched between the insulating film and the insulating film.

### Item 5:

The electricity storage device according to any one of items 1 to 3, wherein
the notch has a semicircular shape or a triangular shape.

One preferred embodiment of the present disclosure has been described above, but it is not intended to limit the technology disclosed herein to the preferred embodiment described above. The technology disclosed herein can be implemented in various other embodiments. The technology described in the scope of claims includes various modifications and changes of the preferred embodiment described as an example above. For example, a portion of the preferred embodiment described above can be replaced with some other modified aspect. Some other modified aspect can be added to the preferred embodiment described above. Additionally, a technical feature can be deleted as appropriate unless the technical feature is described as an essential element.

What is claimed is:

1. An electricity storage device comprising:
an electrode body;
a bag-like insulating film that covers the electrode body;
an electrolyte solution;
a case that houses the electrode body, the insulating film, and the electrolyte solution and includes
a body including a rectangular bottom surface, an opening opposed to the bottom surface, a pair of broad width surfaces each of which extends from a corresponding one of a pair of long sides of the bottom surface that are opposed to each other, and a pair of narrow width surfaces each of which extends from a corresponding one of a pair of short sides of the bottom surface that are opposed to each other, and
a rectangular sealing plate that seals the opening;
an electrode terminal attached to the case; and
a current collecting member connected to the electrode body and the electrode terminal inside the case,
wherein
the sealing plate includes an attachment hole to which the electrode terminal is attached and a liquid injection hole through which the electrolyte solution is injected, and
the insulating film
includes a first side surface opposed to a corresponding one of the broad width surfaces of the body,
is closed at a lower end that is closer to the bottom surface of the body and is opened at an upper end that is closer to the sealing plate, and
has a notch in the upper end in the first side surface, and
in a cross-sectional view along the narrow width surface of the body, the notch is provided under an intersection of a straight line passing through center of the liquid injection hole and extending in a short side direction of the sealing plate and a straight line extending along the first side surface.

2. The electricity storage device according to claim 1, wherein
the notch is provided closer to center of a long side of the sealing plate than a connection portion of the electrode terminal and the current collecting member.

3. The electricity storage device according to claim 1, wherein
the electrode body
is a wound electrode body in which a long sheet-like positive electrode and a long sheet-like negative electrode with a long sheet-like separator interposed therebetween are wound in a longitudinal direction,
includes a first curved portion, a second curved portion, and a flat portion provided between the first curved portion and the second curved portion, and
is housed in the case such that the first curved portion is arranged closer to the sealing plate and the second curved portion is arranged closer to the bottom surface, and
a deepest portion of the notch is provided closer to the sealing plate than a boundary of the first curved portion and the flat portion.

4. The electricity storage device according to claim 3, wherein
the electrode terminal includes
a first conductive portion arranged outside the case,
a second conductive portion arranged inside the case, and
a shaft portion inserted through the attachment hole and connecting the first conductive portion and the second conductive portion,
the current collecting member
extends from the sealing plate toward the electrode body, is connected to the second conducive portion at one end, and is connected to the electrode body at the other end, and
between the boundary in the electrode body and the sealing plate, is sandwiched between the insulating film and the insulating film.

5. The electricity storage device according to claim 1, wherein
the notch has a semicircular shape or a triangular shape.
